(19) United States
(12) Patent Application Publication
(10) Pub. No.: US 2008/0008168 A1
(43) Pub. Date: Jan. 10, 2008

(54) Methods and apparatus for providing optimal identification and processing of layer 3 control channels

(76) Inventors: Thomas D. Nadeau, Hampton, NH (US); Stewart F. Bryant, Merstham (GB); Simon Barber, Bishops Castle (GB); David Ward, Somerset, WI (US); George Swallow, Boston, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, WESTBOROUGH, MA, 01581, US

(21) Appl. No.: 11/482,920

(22) Filed: Jul. 7, 2006

(51) Int. Cl. H04L 12/56

(52) U.S. Cl. 370/389

(57) ABSTRACT

A method for processing token identifiers for Layer 3 (L3) control channels when encapsulated in a tunneling protocol. Rather than encapsulating an L3 control channel with a secondary L3 (or Layer 4 ‘L4 ’) header, a generic (non-Layer 3 header) identifier, or token identifier, is used to encapsulate the control channel. For example, the token identifier may be a simple bit pattern that does not require a complex, confusing or redundant IP/UDP routing table lookup. Instead, the token identifier simply alerts the forwarding entity that local processing of the packet's data is required (e.g., that the packet contains control channel data).

### BACKGROUND

Conventional computer networks include the Internet, Service Provider (SP) networks, enterprise networks, private networks, and Local Area Networks (LANs). A network such as an SP network and enterprise network may include peripherally located Provider Edge (PE) routers, each of which couples to one or multiple Customer Edge (CE) routers. The PE routers are used to maintain routing and forwarding context for each customer. The CE routers may couple to private LANs associated with one or multiple customers. The private LANs are also referred to as core networks. The CE site can be a MAN (Metro Area Network) or WAN (Wide Area Network) as well. The PE routers learn local customer routes from the CE routers and distribute remote customer routes to the CE router using a routing distribution protocol such as OSPF or ISIS. The PEs also utilize a routing protocol such as Border Gateway Protocol (BGP) to distribute customer routes to each other.

In operation, the PE routers typically maintain Virtual Routing and Forwarding (VRF) information in a table (a VRF table) dictating how to route and forward traffic through the shared physical network to support corresponding Virtual Private Networks (VPNs) for the different customers. Similarly, Label Forwarding Information Bases (LFIB's) are used in the forwarding of frames through the network. An LFIB is created by label switch-capable devices and includes a list of entries consisting of an ingress entity and one or more egress subentries (outgoing label, outgoing interface, outgoing link-level components, etc.). The construction of an LFIB is based on information gained by the LSR's interaction with the routing protocol. For the core network, an ingress PE uses BGP functions to determine the egress PE. For example, as an alternative to implementing a pure IP stack, the ingress PE may put the packet in a two-level Multi Protocol Label Switching (MPLS) stack. The top label is used to tunnel packets to the egress PE to accomplish MPLS forwarding through the core network. Generally considered to lie between traditional definitions of Layer 2 (data link layer) and Layer 3 (network layer), MPLS is often referred to as a “Layer 2.5” protocol. MPLS was designed to provide a unified data-carrying service for both circuit-based clients and packet-switching clients which provide a datagram service model. In MPLS, the bottom label is used by the egress PE to identify either the outgoing Forwarding Information Base (FIB) rewrite adjacency or VRF table for another lookup.

Tunneling protocols such as MPLS, Generic Routing Encasulation (GRE), Layer 2 Tunneling Protocol (L2TP), and the like, are network protocols that encapsulate one protocol inside another. By encapsulating one protocol inside another, a virtual ‘tunnel ’is created such that the inner message is transmitted transparently across the outer network infrastructure. Often, the inner payload is encrypted or scrambled, for instance, preventing examination of the inner payload (except for the inner layer 3 header). For example, Protocol Alpha (e.g., IP) is encapsulated within protocol Beta (e.g., MPLS), such that Alpha treats Beta as though it were opaque data. Tunneling may be used to transport a network protocol through a network which would not otherwise support it. Tunneling may also be used to provide various types of VPN functionality such as private addressing.

Various networking protocols are used in large scale networks to facilitate network maintenance and management. Control channels are typically established between at least two forwarding entities in a network such that network maintenance and management data may be transmitted along those control channels. For instance, network packets carrying IP control channel data (e.g., bidirectional forwarding detection (BFD) as discussed in IETF RFC1701, MPLS LSP ping as discussed in IETF RFC4379, etc.) may be used as keepalive protocols to periodically check network connectivity between PE routers in a core network. Additionally, IP control channel packets may be propagated through a network(s) via one or more tunneling protocols.

### SUMMARY

Conventional mechanisms such as those explained above suffer from a variety of deficiencies. One such drawback is that conventional networking technologies provide an inefficient and sub-optimal means for transmitting IP control channel packets via conventional tunneling protocols. More specifically, by encapsulating IP control channel packets within a conventional tunneling technology, the layer 3 (L3) header (and layer 4 ‘L4’ header at times) for the packet may be meaningless, redundant or potentially misleading when combined with a tunneling label or header. For example, conventional networking technologies utilizing such methods and devices may perform unnecessary address look-ups for inner header addresses wasting important processing cycles in the forwarding functions of routers and switches. Further, the meaningless or redundant L3 address header (e.g., IP header) creates the potential for misrouting if a core (P) router incorrectly strips the tunnel encapsulation and processes the inner header prior to its arrival at the egress PE, resulting in the packet being delivered to an incorrect destination within the core network (which can happen due to the commonly overlapping address scheme between the core network and private networks). This is the case, for example, when a provider edge router that is not the egress of the tunnel unexpectedly has the same IP address as the destination IP address in the header and, thus, erroneously processes the packet payload. Moreover, security issues may arise in allowing private network devices to address, or “see”, service provider transport devices that can create vulnerabilities to denial of service or other similar security-related attacks.

Embodiments of the invention significantly overcome such deficiencies and provide mechanisms and techniques for processing token identifiers for L3 control channels when encapsulated in a tunneling protocol. In its operation, rather than encapsulating an L3 control channel with a secondary L3 (or layer 4 ‘L4’) header, a generic (non-IP header) identifier, or token identifier, is used to encapsulate the control channel. For example, the token identifier may be a simple bit pattern that does not require a complex, confusing or redundant IP/UDP routing table lookup. Instead, the token identifier simply alerts the forwarding entity (e.g., the tunnel end point when using BFD) that local processing of the packet's data is required (e.g., that the packet contains control channel data) and, incidentally, prevents the inner packet from being misrouted. Similarly, the token identifier may be a short (non-IP) identifier that is specific to a particular tunneling protocol (e.g., MPLS) but does not specify the particular IP control channel (e.g., MPLS LSP ping) associated with the packet. Alternatively, the generic identifier may be specific to a particular L3 control channel (e.g., BFD) while remaining generic with respect to the tunneling protocol (e.g., L2TP). For example, in one embodiment a generic BFD tunneling header is used for all existing tunneling technologies such that the same BFD token identifier is used in GRE, MPLS, L2TP and the like.

In a particular embodiment of a method for transmitting L3 control packets in a network, the method includes a network having a plurality of forwarding entities operable to transmit message traffic from a particular forwarding entity to another forwarding entity via a tunneling protocol, wherein each forwarding entity has an IP address. The method further includes receiving, at a source forwarding entity in the network, a request for an L3 control packet, wherein the L3 control packet includes control channel data for implementing a control channel operation. At the source forwarding entity, the method further includes adding a token identifier to the L3 control packet, the token identifier indicating that local processing of the L3 control packet is required. Also at the source forwarding entity, the method includes adding a destination address to the L3 control packet in accordance with the tunneling protocol. The method also includes transmitting, from the source forwarding entity in the network, the L3 control packet with the token identifier to a second forwarding entity in accordance with the tunneling protocol.

Additionally at the second forward entity, the method includes receiving the L3 control packet with the token identifier. The method further includes processing, at the second forwarding entity, the L3 control packet with the token identifier.

Other embodiments include a computer readable medium having computer readable code thereon for providing a method for transmitting L3 control packets in a network having a plurality of forwarding entities operable to transmit message traffic from a particular forwarding entity to another forwarding entity via a tunneling protocol, and each forwarding entity has an L3 address. The computer readable medium also includes instructions operable on a processor to receive, at a source forwarding entity in the network, a request for an L3 control packet, wherein the L3 control packet includes control channel data for implementing a control channel operation. The computer. readable medium further includes instructions operable on a processor to add a token identifier to the L3 control packet, the token identifier indicating that local processing of the L3 control packet is required. In addition, the computer readable medium includes instructions operable on a processor to add a destination address to the L3 control packet in accordance with the tunneling protocol. Furthermore, the computer readable medium includes instructions operable on a processor to transmit, from the source forwarding entity in the network, the L3 control packet with the token identifier to a second forwarding entity in accordance with the tunneling protocol. In addition, the computer readable medium includes instructions operable on a processor to receive, at the second forwarding entity, the L3 control packet with the token identifier. The computer readable medium further includes instructions operable on a processor to process, at the second forwarding entity, the L3 control packet with the token identifier.

Still other embodiments include a computerized device configured to process all the method operations disclosed herein as embodiments of the invention. In such embodiments, the computerized device includes a memory system, a processor, communications interface in an interconnection mechanism connecting these components. The memory system is encoded with a process that provides a method for transmitting L3 control packets within a tunneling protocol encapsulation as explained herein that when performed (e.g. when executing) on the processor, operates as explained herein within the computerized device to perform all of the method embodiments and operations explained herein as embodiments of the invention. Thus any computerized device that performs or is programmed to perform up processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing a method for transmitting L3 control packets within a tunneling protocol encapsulation as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Cisco Systems, Inc. of San Jose, Calif.

### BRIEF DESCRIPTION OF THE DRAWINGS

The foregoing will be apparent from the following more particular description of preferred embodiments of the methods and apparatus for providing optimal identification and processing of L3 control channels, as illustrated in the accompanying drawings in which like reference characters refer to the same parts throughout the different views. The drawings are not necessarily to scale, emphasis instead being placed upon illustrating the principles of the methods and apparatus for providing optimal identification and processing of L3 control channels.

FIG. 1 depicts a block diagram of a network environment performing processing token identifiers for L3 control channels when encapsulated in a tunneling protocol.

FIGS. 2A and 2B illustrate L3 control channel packets as used in conventional tunneling protocols.

FIGS. 3A and 3B illustrates L3 control channel packets having a token identifier for processing token identifiers for L3 control channels when encapsulated in a tunneling protocol.

FIGS. 4A and 4B depict a flow diagram of a particular method of performing processing token identifiers for L3 control channels when encapsulated in a tunneling protocol.

FIG. 5 illustrates an example network device architecture for a computer system that performs processing token identifiers for L3 control channels when encapsulated in a tunneling protocol.

### DETAILED DESCRIPTION

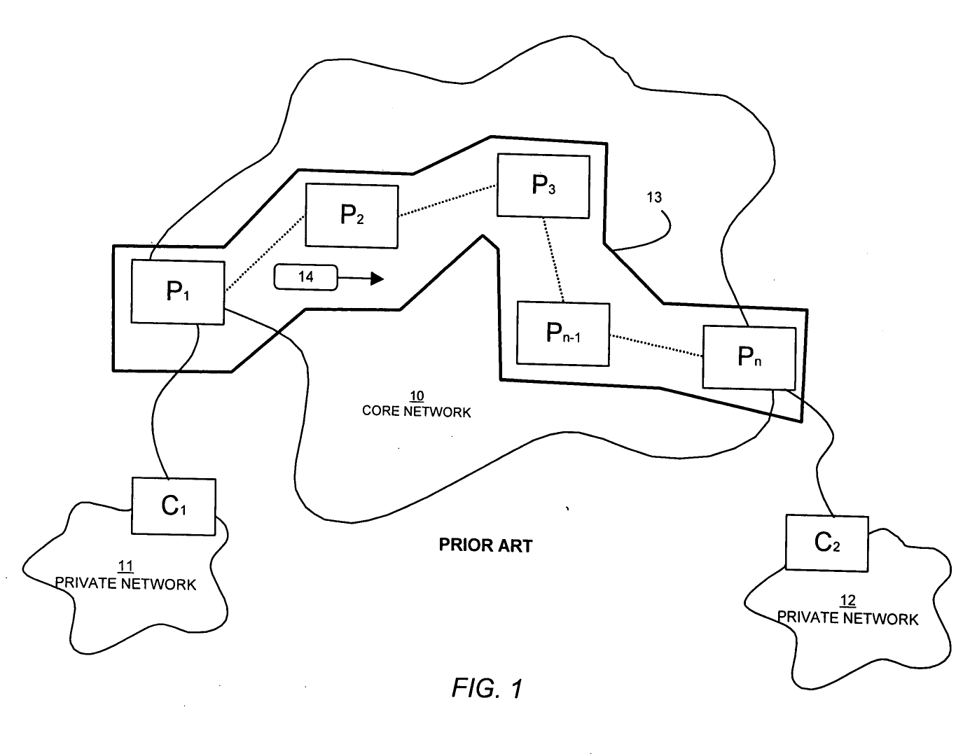

Referring to FIG. 1, a particular embodiment of a core network 10 having a plurality of forwarding entities P₁, P₂. . . Pₙ, operable to transmit message traffic from a particular forwarding entity to another forwarding entity via a tunneling protocol, whereby each forwarding entity P₁, P₂. . . Pₙ, has an Internet Protocol (IP) address is shown. In the example embodiment depicted in FIG. 1, forwarding entity P₁ operates as an ingress provider edge router while forwarding entity Pₙ operates as an egress provider edge router. In turn, forwarding entities P₂, P₃. . . Pₙ₋₁ operate as typical forwarding entities in network 10 between ingress router P₁ and egress router Pₙ and, consequently, form at least one label switching path (LSP) therebetween. Ingress router P₁ interfaces with client edge router C₁ to provide interconnectivity between core network 10 and private network 11. Likewise, egress router Pₙ interfaces with client edge router C₂ to provide interconnectivity between core network 10 and private network 12. Conceptually, the GRE protocol creates a virtual tunnel 13 between P₁ and Pₙ (typically enabled by VRF tables at the forwarding entities). In this example embodiment, forwarding entities P₁, P₂. . . Pₙ, use the generic routing encapsulation (GRE) tunneling protocol to route and propagate packets between provider edge routers (e.g., ingress and egress routers) via the tunnel 13. It should be noted that although GRE is used as the tunneling protocol in this example configuration, other embodiments disclosed herein may use any tunneling protocol suitable for encapsulating and transmitting data in a network through a virtual tunnel.

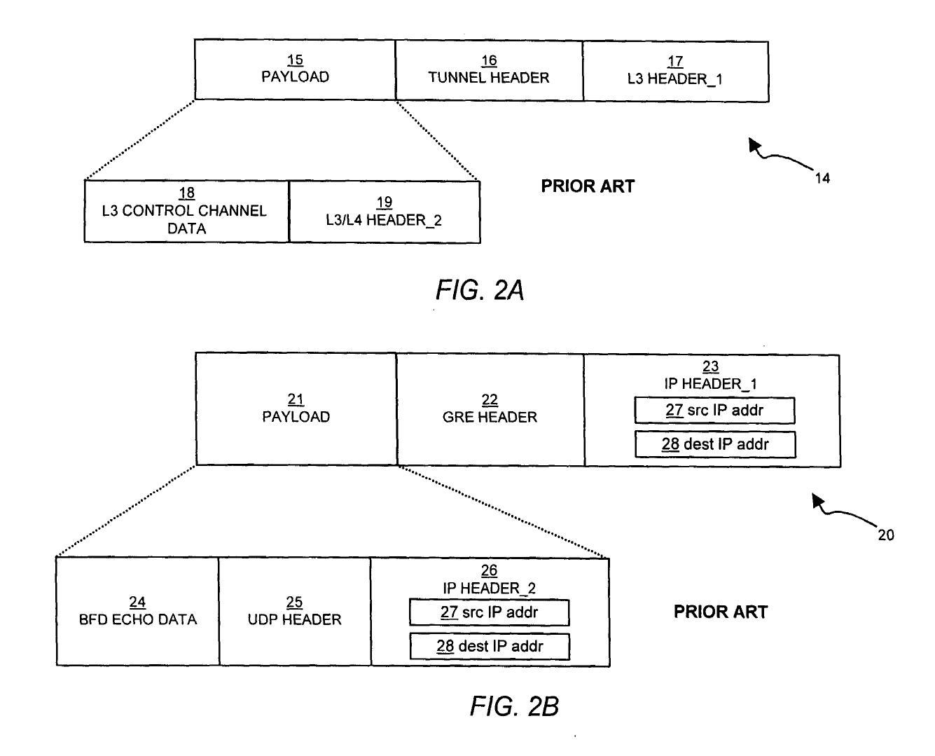

Referring now to FIG. 2A in conjunction with FIG. 1, a typical tunneling protocol packet 14 is shown having a payload section 15, tunnel header section 16 and L3 header _1 section 17. In this example, payload section 15 includes an L3 control channel section 18 (containing L3 control channel data such as BFD data) and L3/L4 header _2 19. The payload section 15 is typically the organic information received by ingress router P1 in network 10 from client edge router C1 in private network 11. Alternatively, the payload section may contain network management or maintenance control data (e.g., BFD) that is generated at various core network endpoints (e.g., P₁ and Pₙ). Upon receiving the payload 15 from client edge router C1 (or at some point shortly thereafter), ingress router P1 encapsulates the payload 15 with tunnel header 16 and L3 header_1 17. In effect, L3 header_1 17 operates as the destination address, or egress router Pₙ's address from FIG. 1, to properly route packet 14 through network 10.

FIG. 2B depicts an example tunneling protocol packet 20 for transmitting a BFD control message encapsulated in the GRE tunneling protocol. BFD packet 20 includes a payload section 21, GRE header section 22 and IP header_1 section 23. Payload section 21 further includes BFD echo data section 24, UDP header section 25 and IP header_2 section 26. In this example, ingress router P1 sends a BFD echo request to egress router Pₙ via a typical IP control channel message. The BFD echo request will cause egress router Pn to transmit an acknowledgement message back to ingress router P1. Furthermore, IP header_1 23 and IP header_2 26 both include a source IP address 27 for ingress router P₁ and destination IP address 28 for egress router Pₙ. The UDP header section 25 contains a port number that triggers specific BFD processing when received by Pₙ. It should be noted that although BFD is used as the exemplary control protocol in this example, the scope of the methods and apparatus disclosed herein contemplate the implementation of any similar control channel protocol (e.g., MPLS LSP ping)

Still referring to FIG. 2B, in processing the BFD packet 20, egress router Pn performs an IP address lookup for IP header_1 23 to determine if the destination IP address 28 is its own address (e.g., Pₙ's IP address) and thus requires further processing. Since the IP header_1 section 23 is coupled with GRE header section 22, GRE tunnel decapsulation processing is triggered and egress router Pₙ strips GRE header section 22 and IP header_1 section 23 from BFD packet 20 leaving payload section 21. Next, egress router Pₙ processes IP header_2 26 and performs a second IP lookup operation and determines that the destination address is its own address (e.g., Pₙ's IP address) and requires further processing (e.g., processing the BFD echo packet 24 and UDP header section 25). Thus, in order to locally process an L3 control channel packet (e.g., BFD echo request in this example), egress router Pₙ must perform a second, or recursive, IP lookup operation for IP header_2 26 in the payload 21 of packet 20. This second/recursive IP lookup is superfluous since the destination address identity (e.g., Pₙ's IP address) has already been ascertained from the initial IP lookup operation. Thus, the routing lookup processing that handles the control channel data is unnecessarily doubled and prevents the router from performing at an optimal level of efficiency.

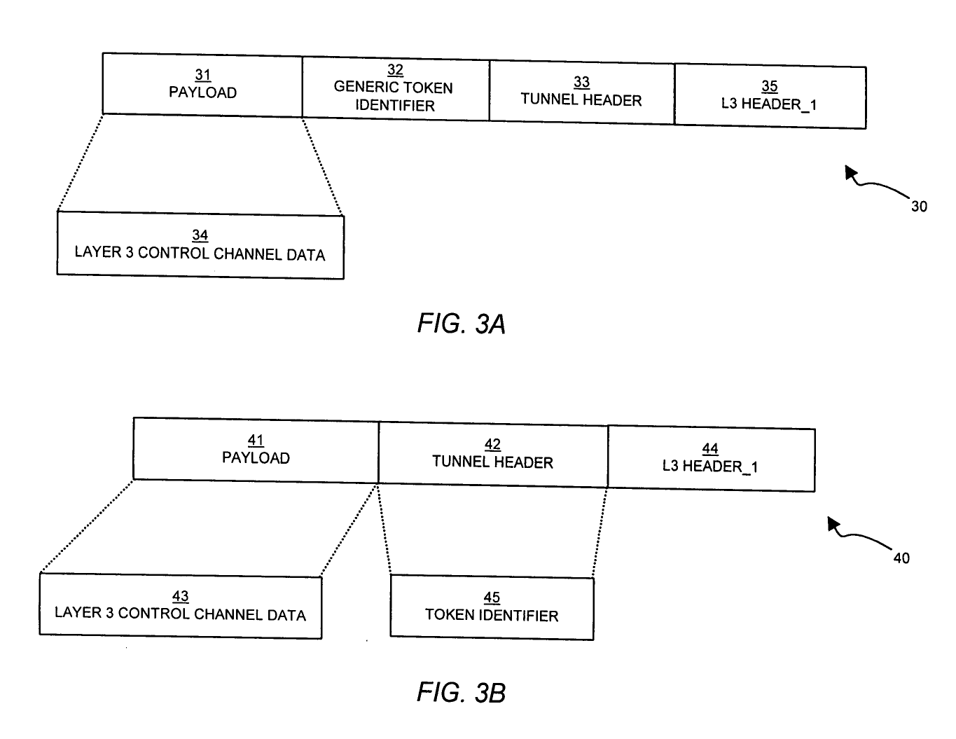

FIG. 3A depicts an example embodiment of an L3 control channel packet 30 encapsulated in a tunneling protocol. L3 control channel packet 30 includes a payload section 31, generic token identifier 32, tunnel header section 33 and L3 Header_1 35. Payload section 31 further includes L3 control channel section 34 (e.g., MPLS LSP ping) for implementing a control channel operation. To obviate the need for a redundant secondary L3 lookup (such as an IP lookup), generic token identifier 32 is substituted for the L3/L4 Header_2 19 as shown in FIG. 2A. Generic token identifier 32 is a non-IP (does not contain address data), type-length-value (TLV) bit pattern that is used in demultiplexing the control channel at the destination router. Thus, instead of performing a costly primary L3 lookup (similar to the processing of IP header section 23 previously discussed), the generic token identifier 32 simply alerts the forwarding entity (e.g., tunnel end point) that local processing of the packet payload 31 is required (e.g., that the packet contains control channel data). Furthermore, when the generic token identifier 32 is maintained separately from the tunneling header as in FIG. 3A, the generic token identifier 32 may indicate a specific control channel protocol (e.g., BFD) while remaining generic with respect to the tunneling protocol (e.g., MPLS). For example, in using the configuration shown in FIG. 3A, the same generic BFD token identifier may be used for any tunneling protocol that routes a BFD control channel packet.

Alternatively, as depicted in the example embodiment of FIG. 3B, the tunnel header 42 of control channel packet 40 may include the token identifier 45 such that processing of only the tunnel header 42 is required for determining the need for local processing of the payload. In this embodiment, fewer clock cycles are needed to process the single tunnel header 42 as compared to processing both the generic token identifier 32 and tunnel header 33 in packet 30. However, unlike the generic token identifier 32 of packet 30, token header 42 is specific to a particular tunneling protocol and cannot port to other tunneling technologies. As such, this approach typically extends the tunneling protocol such that the particular tunneling headers/labels must be modified accordingly in order to account for the additional token header data. For instance, in reference the configuration in FIG. 3B, assume that token identifier 45 is specific to a BFD control channel packet 40 an MPLS tunneling protocol. In this example, the BFD token identifier 45 cannot be used to tunnel BFD control channel data through an L2TP enabled network since the token identifier 45 is specific to MPLS. Despite this, as shown in FIG. 3A, generic token identifier 32 may be standardized across any number of tunneling protocols for specific L3 control channels since the generic token identifier 32 is separate from the tunnel header 33 (and thus processed separately). Nonetheless, more clock cycles are expended in such a configuration (as shown in FIG. 3A) since both the generic token identifier 32 and tunnel header 33 are processed separately.

Referring now to FIG. 3A in conjunction with FIG. 1, when packet 30 is propagated through network 10 via forwarding entities P₂, P₃. . . Pₙ₋₁ , each forwarding entity performs an address lookup operation for L3 Header_1 35 (e.g., an IP lookup operation). Once a forwarding entity P₂, P₃. . . Pₙ₋₁ determines that the L3 Header_1 35 address is not the forwarding entity address, the packet 30 is forwarded/propagated to the next hop in the tunnel 13. Thus, each forwarding entity performs one, and only one, address lookup for packet 30.

Similarly, egress router Pₙ (or any L3 control channel destination router) performs only one address lookup for control channel packet 30 upon its receipt. Since egress router Pₙhas already ascertained that the destination address is the egress router address (via the address lookup operation for L3 Header_{—1} 35, 44), the generic token identifier 33 in FIG. 3A (or token identifier 45 in FIG. 3B) merely instructs egress router Pₙ that local processing of the packet is necessary. Thus, significantly fewer clock cycles are required in processing token identifier 33, 45 vis-à-vis performing an address lookup operation (e.g., an IP lookup).

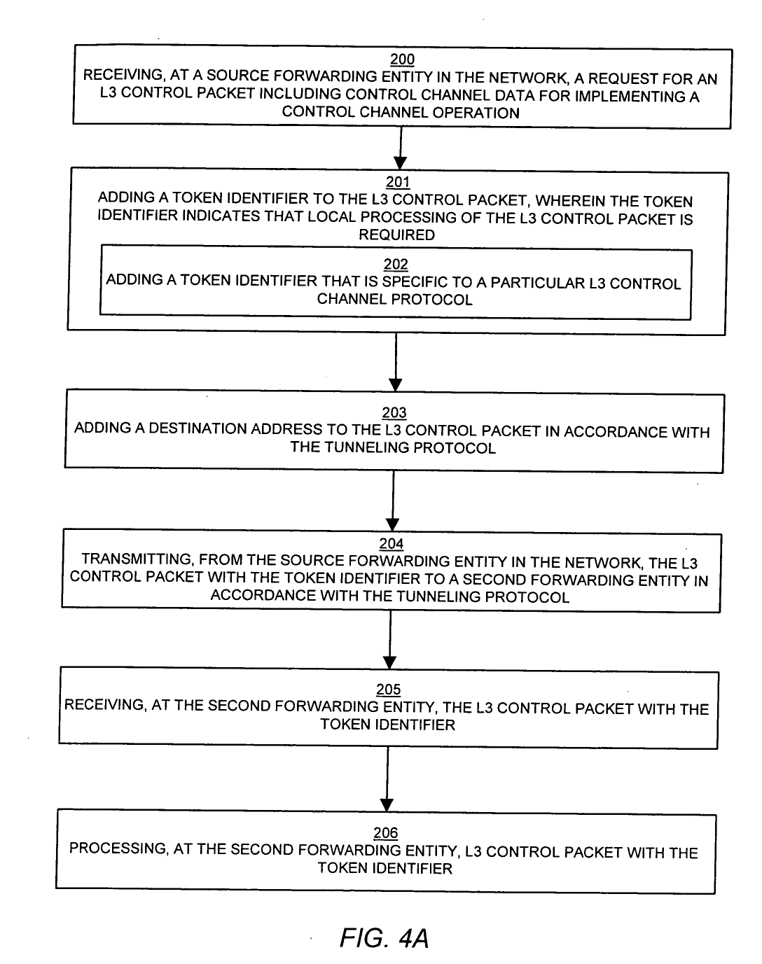

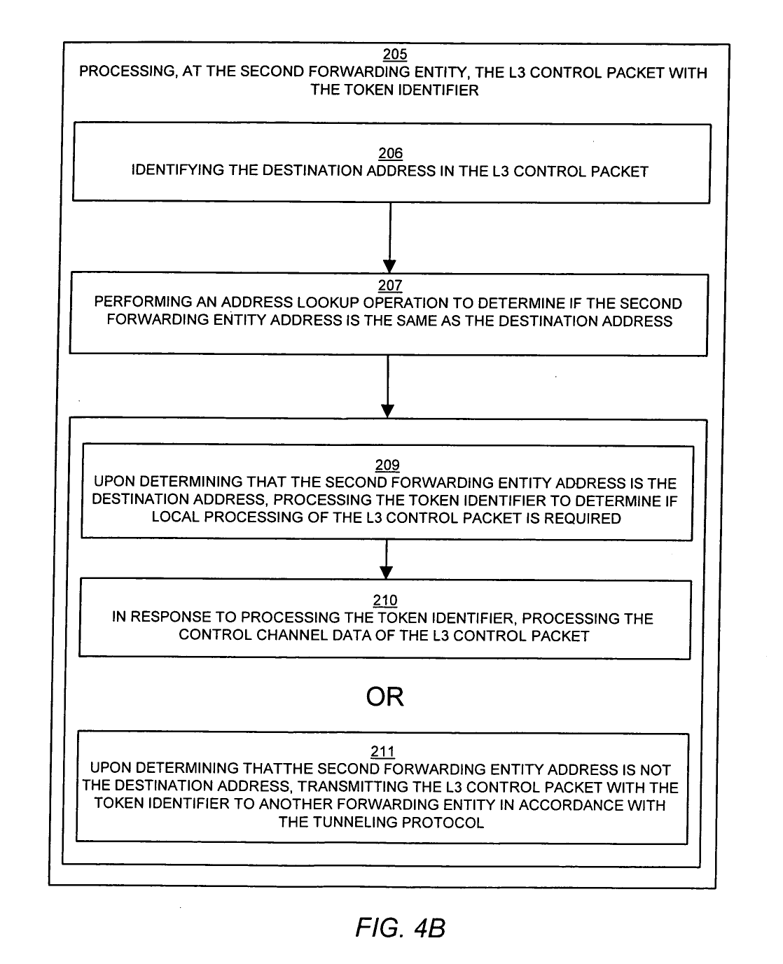

Flow charts of the presently disclosed methods are depicted in FIGS. 4A and 4B. The rectangular elements are herein denoted “processing blocks ” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIGS. 4A and 4B, a method 150 for transmitting IP control packets in a network having a plurality of forwarding entities operable to transmit message traffic from a particular forwarding entity to another forwarding entity via a tunneling protocol, wherein each forwarding entity has an Internet Protocol (IP) address is shown. The method begins with processing block 200 which discloses receiving, at a source forwarding entity in the network, a request for an L3 control packet, wherein the L3 control packet includes control channel data for implementing a control channel operation. Processing block 201 then states adding a token identifier to the L3 control packet, the token identifier indicating that local processing of the L3 control packet is required. Processing block 202 recites adding a token identifier that is specific to a particular L3 control channel protocol (e.g., a token identifier specific to the BFD control channel protocol).

In addition, processing block 203 states adding a destination address to the L3 control packet in accordance with the tunneling protocol. Typically, a destination address and a tunneling header, or label, are added to the L3 control packet in accordance with the tunneling protocol in order to route the packet through the network. For example, a GRE header and a destination IP address (and often a source IP address) are added to an IP control channel packet that is tunneled through a network using a GRE tunneling protocol.

The method continues with processing block 204 which discloses transmitting, from the source forwarding entity in the network, the L3 control packet with the token identifier to a second forwarding entity in accordance with the tunneling protocol.

Processing 205 states receiving, at the second forwarding entity, the L3 control packet with the token identifier. Processing block 206 then discloses processing, at the second forwarding entity, the L3 control packet with the token identifier.

Processing block 207 recites identifying the destination address in the L3 control packet. Processing block 208 states performing an address lookup operation to determine if the second forwarding entity address is the same as the destination address. The method still continues with processing block 209 which discloses, upon determining that the second forwarding entity address is the destination address, processing the token identifier to determine if local processing of the L3 control packet is required. Processing block 210 then recites that, in response to processing the token identifier, processing the control channel data of the L3 control packet

Processing block 211 states, upon determining that second forwarding entity address is not the destination address, transmitting the L3 control packet with the token identifier to another forwarding entity in accordance with the tunneling protocol.

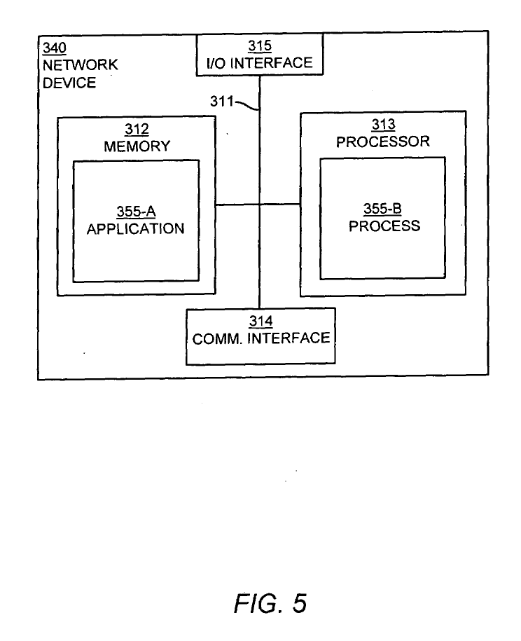

FIG. 5 illustrates example architectures of a network device that is configured as a host computer system 340. The network device 340 may be any type of computerized system such as a personal computer, workstation, portable computing device, mainframe, server or the like. In this example, the system includes an interconnection mechanism 311 that couples a memory system 312, a processor 313, a communications interface 314, and an I/O interface 315. The communications interface 314 and I/O interface 315 allow the computer system 340 to communicate with external devices or systems.

The memory system 312 may be any type of computer readable medium that is encoded with an application 355-A that represents software code such as data and/or logic instructions (e.g., stored in the memory or on another computer readable medium such as a disk) that embody the processing functionality of embodiments of the invention for the agent 355 as explained above. The processor 313 can access the memory system 312 via the interconnection mechanism 311 in order to launch, run, execute, interpret or otherwise perform the logic instructions of the applications 355-A for the host in order to produce a corresponding agent process 355-B. In other words, the agent process 355-B represents one or more portions of the agent application 355-A performing within or upon the processor 313 in the computer system.

It is to be understood that embodiments of the invention include the applications (i.e., the un-executed or non-performing logic instructions and/or data) encoded within a computer readable medium such as a floppy disk, hard disk or in an optical medium, or in a memory type system such as in firmware, read only memory (ROM), or, as in this example, as executable code within the memory system 312 (e.g., within random access memory or RAM). It is also to be understood that other embodiments of the invention can provide the applications operating within the processor 313 as the processes. While not shown in this example, those skilled in the art will understand that the computer system may include other processes and/or software and hardware components, such as an operating system, which have been left out of this illustration for ease of description of the invention.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What we claim is:

1. In a network having a plurality of forwarding entities operable to transmit message traffic from a particular forwarding entity to another forwarding entity via a tunneling protocol, each forwarding entity having a Layer 3 (L3) address, a method for transmitting L3 control packets comprising:
receiving, at a source forwarding entity in the network, a request for an L3 control packet, wherein the L3 control packet includes control channel data for implementing a control channel operation;
adding a token identifier to the L3 control packet, the token identifier indicating that local processing of the L3 control packet is required;
adding a destination address to the L3 control packet in accordance with the tunneling protocol;
transmitting, from the source forwarding entity in the network, the L3 control packet with the token identifier to a second forwarding entity in accordance with the tunneling protocol;
receiving, at the second forwarding entity, the L3 control packet with the token identifier;
processing, at the second forwarding entity, the L3 control packet with the token identifier.

2. The method of claim 1 wherein the processing, at the second forwarding entity, the L3 control packet with the token identifier comprises:
identifying the destination address in the L3 control packet; and
performing an address lookup operation to determine if the second forwarding entity address is the same as the destination address.

3. The method of claim 2 comprising:
upon determining that the second forwarding entity address is the destination address, processing the token identifier to determine if local processing of the L3 control packet is required; and
in response to processing the token identifier, processing the control channel data of the L3 control packet.

4. The method of claim 2 comprising:
upon determining that second forwarding entity address is not the destination address, transmitting the L3 control packet with the token identifier to another forwarding entity in accordance with the tunneling protocol.

5. The method of claim 1 wherein the adding a token identifier to the IP control packet comprises:
adding a token identifier that is specific to a particular L3 control channel protocol.

6. A computer readable medium having computer readable code thereon for providing a method for transmitting Layer 3 (L3) control packets in a network, the network having a plurality of forwarding entities operable to transmit message traffic from a particular forwarding entity to another forwarding entity via a tunneling protocol, each forwarding entity having an L3 address, the medium comprising:
instructions operable on a processor to receive, at a source forwarding entity in the network, a request for an L3 control packet, wherein the L3 control packet includes control channel data for implementing a control channel operation;
instructions operable on a processor to add a token identifier to the L3 control packet, the token identifier indicating that local processing of the L3 control packet is required;
instructions operable on a processor to add a destination address to the L3 control packet in accordance with the tunneling protocol;
instructions operable on a processor to transmit, from the source forwarding entity in the network, the L3 control packet with the token identifier to a second forwarding entity in accordance with the tunneling protocol;
instructions operable on a processor to receive, at the second forwarding entity, the L3 control packet with the token identifier;
instructions operable on a processor to process, at the second forwarding entity, the L3 control packet with the token identifier.

7. The computer readable medium of claim 6 wherein the instructions operable on a processor to process, at the second forwarding entity, the L3 control packet with the token identifier comprises:
instructions operable on a processor to identify the destination address in the L3 control packet; and
instructions operable on a processor to perform an address lookup operation to determine if the second forwarding entity address is the same as the destination address.

8. The computer readable medium of claim 7 comprising:
upon determining that the second forwarding entity address is the destination address, instructions operable on a processor to process the token identifier to determine if local processing of the L3 control packet is required; and
in response to processing the token identifier, instructions operable on a processor to process the control channel data of the L3 control packet.

9. The computer readable medium of claim 7 comprising:
upon determining that second forwarding entity address is not the destination address, instructions operable on a processor to transmit the L3 control packet with the token identifier to another forwarding entity in accordance with the tunneling protocol.

10. The computer readable medium of claim 6 wherein the instructions operable on a processor to add a token identifier to the L3 control packet comprises:
instructions operable on a processor to add a token identifier that is specific to a particular L3 control channel protocol.

11. A network device comprising:
a memory;
a processor;
a communications interface;
an interconnection mechanism coupling the memory, the processor and the communications interface; and
wherein the memory is encoded with an identification manager application that when performed on the processor, provides an identification manager process for processing information in a network having a plurality of forwarding entities operable to transmit message traffic from a particular forwarding entity to another forwarding entity via a tunneling protocol, each forwarding entity having a Layer 3 (L3) address, the identification manager process causing the network device to be capable of performing the operations of:
receiving, at a source forwarding entity in the network, a request for an L3 control packet, wherein the L3 control packet includes control channel data for implementing a control channel operation;
adding a token identifier to the L3 control packet, the token identifier indicating that local processing of the L3 control packet is required;
adding a destination address to the L3 control packet in accordance with the tunneling protocol;
transmitting, from the source forwarding entity in the network, the L3 control packet with the token identifier to a second forwarding entity in accordance with the tunneling protocol;
receiving, at the second forwarding entity, the L3 control packet with the token identifier;
processing, at the second forwarding entity, the L3 control packet with the token identifier.

12. The network device of claim 11 wherein the processing, at the second forwarding entity, the L3 control packet with the token identifier comprises:
identifying the destination address in the L3 control packet; and
performing an address lookup operation to determine if the second forwarding entity address is the same as the destination address.

13. The network device of claim 12 comprising:
upon determining that the second forwarding entity address is the destination address, processing the token identifier to determine if local processing of the L3 control packet is required; and
in response to processing the token identifier, processing the control channel data of the L3 control packet.

14. The network device of claim 12 comprising:
upon determining that second forwarding entity address is not the destination address, transmitting the L3 control packet with the token identifier to another forwarding entity in accordance with the tunneling protocol.

15. The network device of claim 11 wherein the adding a token identifier to the L3 control packet comprises:
adding a token identifier that is specific to a particular L3 control channel protocol.

16. A network device comprising:
a memory;
a processor;
a communications interface;
an interconnection mechanism coupling the memory, the processor and the communications interface; and
wherein the memory is encoded with an identification manager application that when performed on the processor, provides an identification manager process for processing information in a network operable to transmit message traffic via a tunneling protocol, the identification manager process causing the network device to be capable of performing the operations of: receiving, at a source forwarding entity in the network having Layer 3 (L3) address, a request for an L3 control packet, wherein the L3 control packet includ control channel data for implementing a control channel operation;
adding a token identifier to the L3 control packet, the token identifier indicating that local processing of the L3 control packet is required;
adding a destination address to the L3 control packet in accordance with the tunneling protocol;
transmitting, from the source forwarding entity in the network, the L3 control packet with the token identifier to a second forwarding entity in accordance with the tunneling protocol.

17. The network device of claim 16 wherein receiving, at a source forwarding entity in the network having Layer 3 (L3) address, a request for an L3 control packet comprises:
receiving a request for an L3 control packet from a router.

18. The network device of claim 16 wherein receiving, at a source forwarding entity in the network having Layer 3 (L3) address, a request for an L3 control packet comprises:
receiving a request for an L3 control packet from a local process.

19. The network device of claim 16 wherein the adding a token identifier to the L3 control packet comprises:
adding a token identifier that is specific to a particular L3 control channel protocol.

20. A network device comprising:
a memory;
a processor;
a communications interface;
an interconnection mechanism coupling the memory, the processor and the communications interface; and
wherein the memory is encoded with an identification manager application that when performed on the processor, provides an identification manager process for processing information in a network operable to transmit message traffic via a tunneling protocol, the identification manager process causing the network device to be capable of performing the operations of:
receiving, at a forwarding entity in the network having a Layer 3 (L3) address, an L3 control packet including:
i) a destination address;
ii) control channel data for implementing a control channel operation; and
iii) a token identifier indicating that local processing of the L3 control packet is required; and
processing, at the second forwarding entity, the L3 control packet with the token identifier.

21. The network device of claim 20 wherein the processing, at the second forwarding entity, the L3 control packet with the token identifier comprises:
identifying the destination address in the L3 control packet; and
performing an address lookup operation to determine if the forwarding entity address is the same as the destination address.

22. The network device of claim 21 comprising:
upon determining that the second forwarding entity address is the destination address, processing the token identifier to determine if local processing of the L3 control packet is required; and
in response to processing the token identifier, processing the control channel data of the L3 control packet.

23. The network device of claim 21 comprising:
upon determining that the forwarding entity address is not the destination address, transmitting the L3 control packet with the token identifier to another forwarding entity in accordance with the tunneling protocol.

24. The network device of claim 20 wherein the token identifier is specific to a particular L3 control channel protocol.
